(19) United States
(12) Patent Application Publication
(10) Pub. No.: US 2005/0086148 A1
(43) Pub. Date: Apr. 21, 2005

(54) Investment structures, methods and systems involving derivative securities

(76) Inventors: Kevin G. Woodruff, New York, NY (US); Serkan Savasoglu, New York, NY (US); Nathan McMurtray, New York, NY (US)

Correspondence Address: KIRKPATRICK & LOCKHART , LLP;MICHAEL D. LAZZARA ESQ., 535 SMITHFIELD STREET, HENRY W. OLIVER BUILDING, PITTSBURGH, PA, 15222-2313, US

(21) Appl. No.: 10/689,136

(22) Filed: Oct. 20, 2003

(51) Int. Cl. G06F 17/60

(52) U.S. Cl. 705/36

(57) ABSTRACT

A method for utilizing derivative securities is disclosed. According to one embodiment, the method includes steps for a first entity obtaining a call option from a second entity, wherein the call option comprises a first maturity date. In addition, the method also includes steps for issuing a forward contract to the second entity, wherein the forward contract comprises a second maturity date.

### BACKGROUND

In order to raise capital, business entities may issue conventional securities such as, for example, straight debt and common stock. Straight debt securities (e.g., bonds, notes, loans, mortgages) enable entities to generate capital by borrowing and promising to pay interest until or at the maturity date and the principal amount at the maturity date of the straight debt security. Equity securities (e.g., common stock) enable entities to generate capital by selling an equity interest in the entity. Owners of common stock (“stockholders”) may receive shares of common stock with voting rights regarding firm matters and may benefit through appreciation of the stock value and/or through receiving dividends.

In addition to issuing stock, firms may also desire to repurchase shares of common stock from stockholders. Share repurchase is a program by which a firm buys back shares of stock of the firm from stockholders and thus reduces the number of total shares of stock outstanding (“TSO”).

Issuing derivative securities is one method by which firms may repurchase shares of outstanding stock. Derivative securities include securities whose values are determined by the market price of some underlying asset such as, for example, stock. In addition, derivative securities may include, among other things, put options. A put option involves an option contract that gives its holder the right (but not the obligation) to sell a specified number of shares of an underlying stock at a given strike price on or before the expiration date of the contract. The holder is considered to have exercised the put option when the holder sells the stock pursuant to the option contract at the strike price, which is the stated price per share for which the underlying stock may be sold.

In addition to directly repurchasing shares of common stock from shareholders, a firm may, for example, issue a put option on shares of its own stock. This type of transaction is conventionally referred to as an “issuer put” and may be considered by federal, state, and/or local laws, regulations, rules and/or policies as a nontaxable event because the firm is executing a transaction involving its own stock. Consequently, put options feature the economic and tax advantage of receiving a nontaxable upfront premium for the sale of the option. However, a disadvantage to issuing a put option is that, if the stock price of the firm falls below the strike price, the put option is considered to be “in-the-money” and thus the firm is obligated to pay, in the form of cash or stock, the difference between the strike price and the stock price. Alternatively, the firm may also satisfy its put option obligation by acquiring shares of stock at the strike price.

In addition, firms considering these transactions need to consider federal, state, and/or local laws, regulations, rules and/or policies that address taxation and accounting of income and any corresponding future obligation. For example, the Financial Accounting Standards Board (“FASB”), an organization that is authorized by the United States Securities and Exchange Commission (“SEC”), has established United States Generally Accepted Accounting Principles (“GAAP”) that require put options issued by a firm for the stock of the firm to be recorded as a liability rather than equity. In addition, these rules also require issuer puts to be marked-to-market through the income statement of the firm.

At the end of every reporting period, a firm that issues put options records the fair value of the put options as a liability on the balance sheet. In addition, the change in the fair value of the put options is also reflected in the income statement and in retained earnings on the balance sheet. Therefore, although put options may involve the aforementioned advantages, the accounting treatment associated with issuer puts may cause reported earnings to vary from reporting period to reporting period. This earnings variation complicates cross-period comparisons and forecasts, thereby making the issuance of a put option less attractive to a firm attempting to repurchase shares of its own stock.

### SUMMARY

In one example of the present embodiments, a method is provided for a first entity obtaining a call option from a second entity, wherein the call option comprises a first maturity date, and issuing a forward contract to the second entity, wherein the forward contract comprises a second maturity date.

In another example of the present embodiments, a computer-readable medium is provided including instructions for a first entity obtaining a call option from a second entity, wherein the call option comprises a first maturity date, and issuing a forward contract to the second entity, wherein the forward contract comprises a second maturity date.

In another example of the present embodiments, a system is provided for a first entity obtaining a call option from a second entity, wherein the call option comprises a first maturity date, and issuing a forward contract to the second entity, wherein the forward contract comprises a second maturity date.

In one example of the present embodiments, a method is provided for a financial entity structuring a transaction between a first entity and a second entity, wherein the transaction includes a forward contract and/or a call option.

### DESCRIPTION OF THE FIGURES

FIGS. 1A, 1B, and 1C include schematic representations of various example aspects of the present embodiments;

FIG. 2 is a flowchart illustrating a method according to the present embodiments; and

FIG. 3 includes a schematic system diagram of various example aspects of the present embodiments.

### DETAILED DESCRIPTION

Various aspects of the present embodiments are derivative securities that generate potential economic results similar to an issuer put. However, unlike issuer puts, the derivative transactions of the present embodiments may not require a firm to account for the derivative securities as a liability on the balance sheet, and thus not require the derivative securities to be marked-to-market through the income statement of the firm.

All statements herein reciting embodiments of the present invention, as well as specific examples thereof, are intended to encompass both structural and functional equivalents thereof. Moreover, it is intended that such equivalents include both currently known equivalents as well as equivalents developed in the future for performing the same function, regardless of structure. Thus, those skilled in the art will appreciate that the drawings presented herein and the like, represent conceptual views of illustrative structures which may embody the various aspects of this invention.

It is to be understood that the figures and descriptions of the investment structures, methods and systems utilizing derivative securities have been simplified to illustrate elements that are relevant for a clear understanding of the illustrative embodiments while eliminating, for purposes of clarity, other elements of a conventional security transaction. For example, conventional security transactions include certain sign-off and confirmation procedures that are not described herein. Those of ordinary skill in the art will recognize, however, that these and other elements may be desirable in a typical security transaction. However, because such elements are well known in the art and because they do not facilitate a better understanding of the security transaction, a discussion of such elements is not provided herein.

Also, in the claims appended hereto or added hereafter, any element expressed as a means for performing a specified function is to encompass any way of performing that function including, for example, a combination of elements that perform that function. Furthermore, the invention, as defined using such means-plus-function elements, resides in the fact that the functionalities provided by the various recited means are combined and brought together in the manner set out in the claims. Therefore, any means that can provide such functionalities may be considered equivalents to the means shown herein.

In addition, those skilled in the art will appreciate that the term “business entity” as used herein is synonymous with the term “company” and/or “firm” and includes a proprietorship, partnership, corporation or any other form of enterprise that engages in business. In addition, the term “financial entity” as used herein may include investment banks, brokers, dealers and/or any other financial institution capable of purchasing, selling, lending, borrowing and/or otherwise processing securities.

As employed in accordance with various embodiments discussed herein, “securities” may include: (1) debt securities such as, for example, bonds, notes, loans, mortgages and/or any other financial instrument involving borrowing and promising to repay a principal amount and interest on or until a specified future date; (2) equity securities such as, for example, common stock, preferred stock or any other financial instrument that confers an ownership interest in a business entity; (3) hybrid securities such as, for example, convertible bonds, convertible preferred stock or any other security that can be converted into common stock at the option of the security holder; (4) derivative securities such as, for example, put options, call options, warrants, forward contracts and/or any other financial instrument whose value is determined by the market price of some underlying asset.

As used herein, a “call option” involves an option contract that gives its holder the right (but not the obligation) to purchase a specified number of shares of the underlying stock at a given strike price on or before the expiration date of the contract. If the stock price rises above the strike price, the call option is considered to be “in-the-money” and thus the issuing firm is obligated to settle the call option. The issuing firm may determine the form in which the call option is settled such as, for example, by delivering cash or stock equal to the difference between the stock price and the strike price. In addition, the issuing firm may also satisfy its call option obligation by delivering shares of stock upon receiving the strike price. However, if the stock price falls below the strike price, the call option is considered to be “out-of-the-money” or “at-the-money” and thus the option holder will most likely not exercise the call option.

A “put option,” as used herein, involves an option contract that gives its holder the right (but not the obligation) to sell a specified number of shares of the underlying stock at a given strike price on or before the expiration date of the contract. If the stock price falls below the strike price, the put option is considered to be “in-the-money” and thus the issuing firm is obligated to settle the put option. The issuing firm may determine the form in which the put option is settled such as, for example, by delivering cash or stock equal to the difference between the strike price and the stock price. In addition, the issuing firm may also satisfy its put option obligation by acquiring shares of stock by paying the strike price. However, if the stock price rises above the strike price, the put option is considered to be “out-of-the-money” or “at-the-money” and thus the option holder will most likely not exercise the option.

Derivative securities may also include “forward contracts.” According to one embodiment, a forward contract may include a first party delivering finds (e.g., cash, property, etc.) for an asset, such as for example shares of stock, for a specified price and a second party agreeing to deliver the asset on a specified future date. In another embodiment, a forward contract may include the first party agreeing to deliver funds for an asset on a first future date for a specified price and the second party agreeing to deliver the asset on a second future date, which may or may not be the same as the first future date. In addition, the pricing of the forward contract 16 may reflect whether the funds from the first party are delivered at the time the parties enter into the forward contract 16 or whether funds from the first party are delivered at some future date on, before or after maturity of the forward contract.

Those skilled in the art will appreciate that the term “derivative security” also includes any terms and conditions associated with the delivery, holding and/or exercising of the security such as, for example, assignment, hedge, and/or dividend rights and obligations.

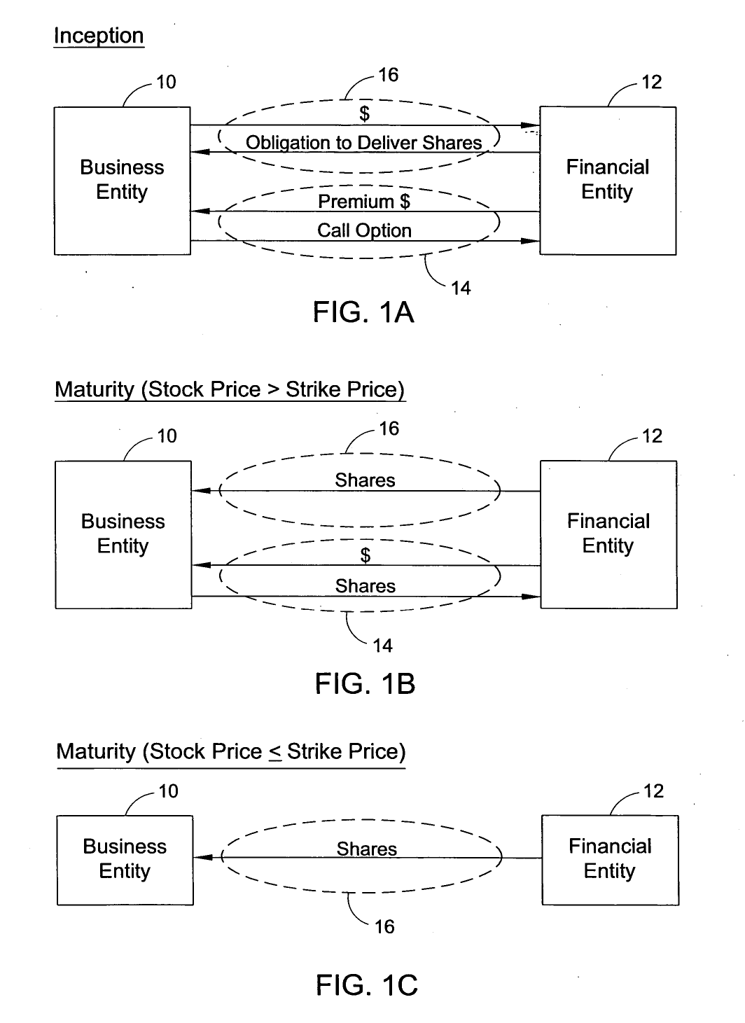

Referring now to FIG. 1A, in various aspects of the present embodiments, an example schematic is shown involving at least two derivative transactions between, for example, a business entity 10 and a financial entity 12. According to this example, at inception the first derivative transaction may involve the financial entity 12 paying a premium for a call option 14 issued/wrote by the business entity 10, wherein the call option 14 includes a specified strike price and a first maturity date. In addition, the second derivative transaction may involve the financial entity 12 entering into a forward contract 16 that may, according to one embodiment, include a second maturity date set to expire after the first maturity date. In other embodiments, the second maturity date may be set to expire before the first maturity date or at the same date as the first maturity date. It can be appreciated that the business entity 10 and the financial entity 12 can enter into the forward contract 16 and the call option 14 simultaneously or in any sequence.

According to various embodiments, the financial entity 12 may structure the transaction, issuance and receipt of the forward contract 16 and/or the call option 14 between two separate entities such as, for example, two business entities or a business entity 10 and another financial entity 12. According to one such embodiment, the financial entity 12 may price the forward contract 16 and/or the call option 14 using, for example, pricing models, data regarding recent similar deals, etc. In addition, the financial entity 12 may market the forward contract 16 and/or the call option 14 to potential investors and underwrite the issuance of the forward contract 16 and/or the call option 14. Additionally, the financial entity 12 may structure the forward contract 16 and/or the call option 14. That is, determine the terms and conditions of the forward contract 16 and/or the call option 14 such as, for example, determining the terms and conditions regarding which entity issues the derivative securities.

According to one embodiment, the forward contract 16 may require the business entity 10 to pay an agreed price, which may reflect the current stock price of the business entity 10 on the day the forward contract 16 is executed, in return for the financial entity 12 delivering a promissory note that obligates the financial entity 12 to deliver a specified amount of common stock of the business entity 10 to the business entity 10 at a certain maturity date. According to this embodiment, the issuance of the forward contract 16 may reduce the TSO of the business entity 10 by the specified number of shares of stock of the business entity 10 underlying the forward contract 16.

In one embodiment, the financial entity 12, upon exercising the call option 14, may receive restricted stock from the business entity 10. Because restricted stock may be subject to special laws, regulations, rules, and/or policies, the maturity date of the forward contract 16 may be set to expire after the maturity date of the call option 14 to enable the financial entity 12 to deliver the restricted stock back to the business entity 10.

According to another embodiment, the forward contract 16 may comprise terms and conditions that require the financial entity 12 to transfer to the business entity 10 dividends and/or other distributions paid on the shares of stock underlying the forward contract 16. Dividends may, for example, be in the form of cash, stock and/or property, and distributions may, for example, include issuance of debt, equity, hybrid and/or derivative securities. The business entity 10 may also choose to receive the dividends and/or distributions in the aforementioned forms or in shares of stock of the business entity 10 equal to the value of the dividends and/or distributions. According to one embodiment, the business entity 10 may pay a premium for the forward contract 16 that requires the financial entity 12 to transfer dividends and/or other distributions to the business entity 10.

According to another embodiment, the issuance of the forward contact 16, which requires the financial entity 12 to transfer to the business entity 10 dividends and/or other distributions, may not only decrease TSO, but also cause the income available to common stockholders of the business entity 10 to remain substantially constant, thereby increasing the earnings-per-share (“EPS”) of the business entity.

Conversely, the forward contract 16 may, according to another embodiment, comprise terms and conditions that do not require the financial entity 12 to transfer to the business entity 10 dividends and/or other distributions paid on the shares of stock of the business entity 10 underlying the forward contract 16. According to this embodiment, the issuance of the forward contract 16 may decrease the income available to common stockholders of the business entity 10 at a rate similar to that of TSO, thereby causing the EPS of the business entity 10 to remain substantially constant.

In another embodiment, the forward contract 16 and/or the call option 14 may also comprise terms and conditions that enable the business entity 10 and/or the financial entity 12 to assign their respective rights in the derivative securities to a third party.

According to another embodiment, the forward contract 16 and/or the call option 14 may provide a return to the business entity 10 that is substantially equivalent to tax-free interest because, according to federal, state, and/or local laws, regulations, rules and/or policies, no gain or loss may be recognized by a business entity 10 with respect to any lapse or acquisition of an option on shares of stock of the business entity 10 or with respect to a securities future contract to buy or sell shares of stock of the business entity 10.

The financial entity 12 may, in various aspects of the present embodiments, hedge the risk associated with the forward contract 16 and/or the call option 14. According to one embodiment, the financial entity 12 assumes the risk of stock price fluctuations that may occur from the time of entering into the forward contract 16 and/or the call option 14 to the time of executing a hedge for the forward contract 16 and/or the call option 14. In addition, the financial entity 12 may adjust for the assumed risk in the pricing of the forward contract 16 and/or the call option 14. In other embodiments, the business entity 10 assumes the risk of stock price fluctuations that may occur from the time of entering into the forward contract 16 and/or the call option 14 to the time of executing a hedge for the forward contract 16 and/or the call option 14.

FIGS. 1B and 1C illustrate example scenarios involving exercising the derivative securities at maturity when the stock price is greater than the strike price of the call option 14 (as shown in FIG. 1B) and when the stock price is less than (or equal to) the strike price of the call option 14 (as shown in FIG. 1C). Although FIGS. 1B and 1C illustrate the forward contract 16 and the call option 14 expiring on the same date, the forward contract 16 may, according to various embodiments, expire before or after the call option 14.

As shown in FIG. 1B, if the stock price at maturity is greater than the strike price of the call option 14, the call option 14 is considered to be “in-the-money,” and thus the financial entity 12 may exercise the call option 14. In addition, the financial entity 12 may also satisfy its obligation on the forward contract 16 and deliver the specified number of shares to the business entity 10, thereby replicating substantially the same economic result as that of an issuer put.

As shown in FIG. 1C, if the stock price at maturity is less than (or equal to) the strike price of the call option 14, the call option 14 is considered to be “out-of-the-money” and thus the financial entity 12 may not exercise the call option 14. However, the financial entity 12 may satisfy its obligation under the forward contract 16 by delivering the specified number of shares, thereby replicating substantially the same economic result as that of an issuer put.

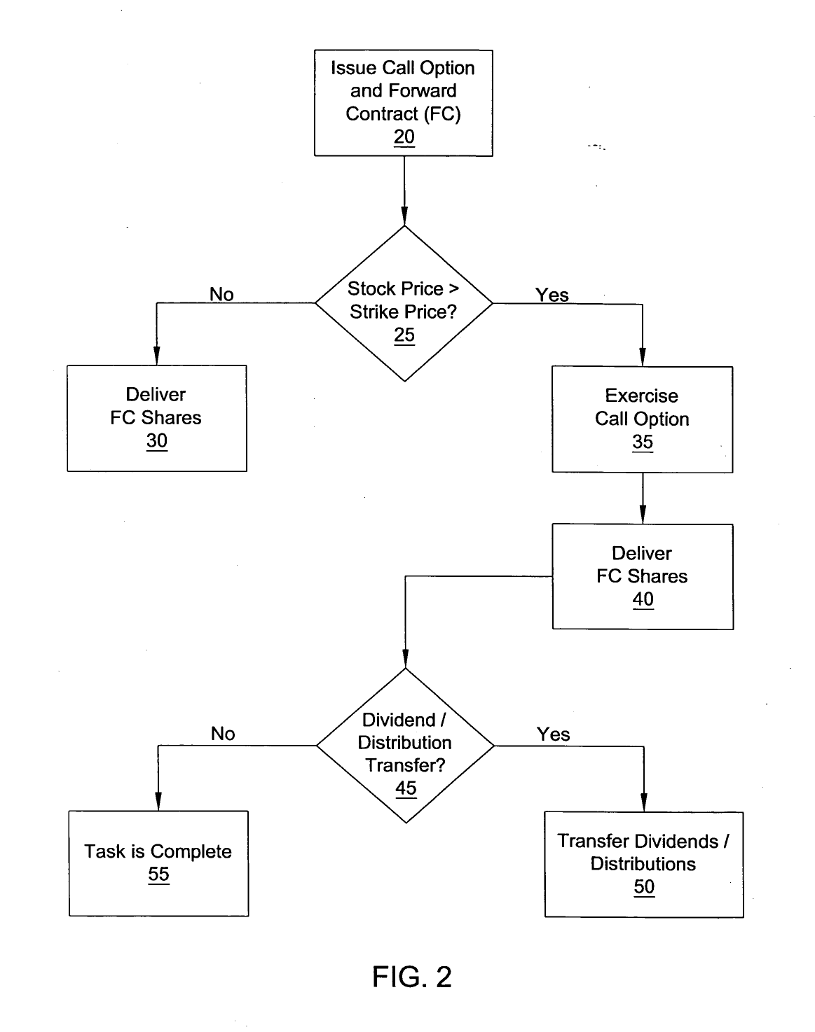

Referring now to FIG. 2, in accordance with previous discussion hereinabove, various example aspects of the present embodiments are illustrated. At inception, the business entity 10 may issue the call option 14 and the financial entity 12 may issue the forward contract 16, as shown in step 20.

In step 25, the financial entity 12 may determine whether the stock price at maturity is greater than the strike price of the call option 14. If the current stock price at maturity is less than (or equal to) the strike price of the call option 14, the financial entity 12 may not exercise the call option 14. However, the financial entity 12 may satisfy its obligation pursuant to the forward contract 16 by delivering the specified number of shares to the business entity 10 in step 30.

If the stock price at maturity is greater than the strike price of the call option 14, the financial entity 12 may exercise the call option 14 in step 35. In step 40, the financial entity 12 may also satisfy its obligation pursuant to the forward contract 16 by delivering the specified number of shares to the business entity 10.

The process may then proceed to step 45 where the financial entity 12 may determine whether the forward contract 16 requires the financial entity 12 to transfer to the business entity 10 dividends and/or other distributions paid on the shares underlying the forward contract 16. If the forward contract 16 requires dividend and/or distribution transfer, the financial entity 12 may transfer to the business entity 10 in step 50 the dividends and/or other distributions paid on the shares underlying the forward contract 16. However, if no dividend and/or distribution transfer are required, the task is completed at step 55. Although FIG. 2 shows dividend and/or distribution transfer after maturity of the forward contract 16, dividend and/or distribution transfer may occur at or before the maturity of the forward contract 16.

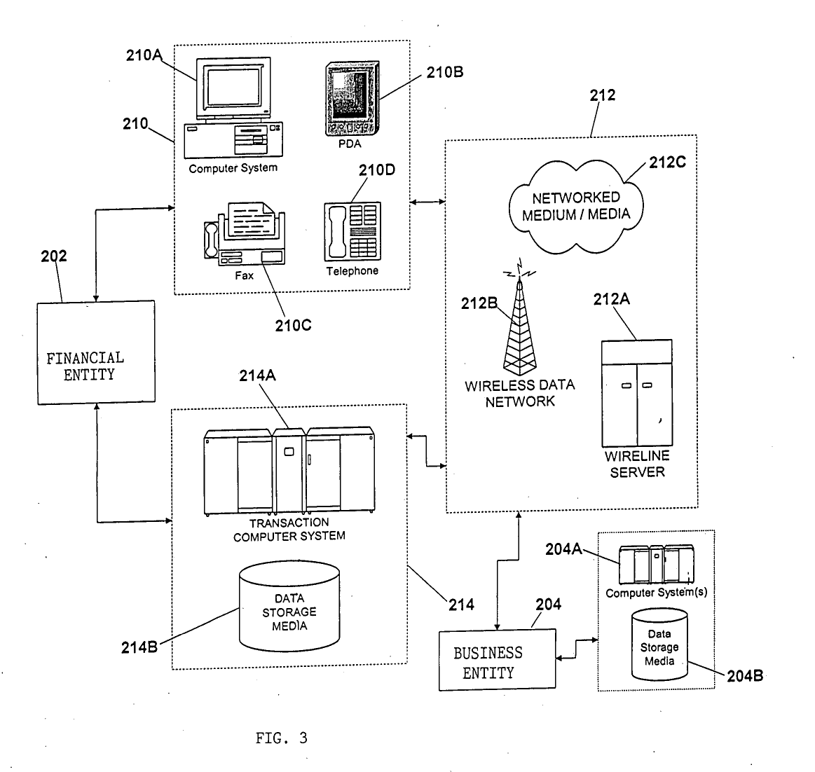

Referring now to FIG. 3, one illustrative system embodiment is provided in accordance with the practice of the present methods, systems and computer-readable media. As shown, a financial entity 202 may, for example, communicate and/or exchange data with a business entity 204. In one aspect, the financial entity 202 can be operatively associated with one or more communications devices 210 such as, for example and without limitation, a computer system 210A, a personal digital assistant 210B, a fax machine 210C, and/or a telephone 210D (e.g., a wireline telephone, a wireless telephone, a pager, and the like), and/or other like communication devices. The communication devices 210 permit the financial entity 202 and the business entity 204 to communicate between/among each other through one or more communication media 212, such as by use of electronic mail communication through one or more computer systems, for example. The communication media 212 can include, for example and without limitation, wireline communication means such as a wireline server 212A, a wireless data network 212B, and/or a connection through a networked medium or media 212C (e.g., the Internet, an extranet, an intranet, a wide area network (WAN), and/or a local area network (LAN).

In addition, the financial entity 202 (as well as the business entity 204) can be operatively associated with one or more data processing/storage devices such as data processing/storage devices 214, for example. As illustrated in FIG. 3, the financial entity 202 can be operatively associated with a transaction computer system 214A, for example, and/or one or more data storage media 214B that can receive, store, analyze and/or otherwise process data and other information in association with communications that occur between/among the financial entity 202 and the business entity 204. In another aspect, the business entity 204 can be operatively associated with one or more computer systems 204A and/or one or more data storage media 204B such as, for example, an accounting and/or tax system that accounts for the derivative transactions that occur between/among the financial entity 202 and the business entity 204.

The term “computer-readable medium” is defined herein as understood by those skilled in the art. It can be appreciated, for example, that method steps described herein may be performed, in certain embodiments, using instructions stored on a computer-readable medium or media that direct a computer system to perform the method steps. A computer-readable medium can include, for example and without limitation, memory devices such as diskettes, compact discs of both read-only and writeable varieties, digital versatile discs (DVD), optical disk drives, and hard disk drives. A computer-readable medium can also include memory storage that can be physical, virtual, permanent, temporary, semi-permanent and/or semi-temporary. A computer-readable medium can further include one or more data signals transmitted on one or more carrier waves.

As used herein, a “computer” or “computer system” may be, for example and without limitation, either alone or in combination, a personal computer (PC), server-based computer, main frame, microcomputer, minicomputer, laptop, personal data assistant (PDA), cellular phone, pager, processor, including wireless and/or wireline varieties thereof, and/or any other computerized device capable of configuration for processing data for either standalone application or over a networked medium or media. Computers and computer systems disclosed herein can include memory for storing certain software applications used in obtaining, processing, storing and/or communicating data. It can be appreciated that such memory can be internal or external, remote or local, with respect to its operatively associated computer or computer system. The memory can also include any means for storing software, including a hard disk, an optical disk, floppy disk, ROM (read only memory), RAM (random access memory), PROM (programmable ROM), EEPROM (extended erasable PROM), and other suitable computer-readable media.

It can be appreciated that, in some embodiments of the present methods and systems disclosed herein, a single component can be replaced by multiple components, and multiple components replaced by a single component, to perform a given function or functions. Except where such substitution would not be operative to practice the present methods and systems, such substitution is within the scope of the present invention.

Examples presented herein are intended to illustrate potential implementations of the present method and system embodiments. It can be appreciated that such examples are intended primarily for purposes of illustration. No particular aspect or aspects of the example method, product, computer-readable media, and/or system embodiments described herein are intended to limit the scope of the present invention.

It should be appreciated that figures presented herein are intended for illustrative purposes and are not intended as construction drawings. The basic components of derivative securities may, for example, be embodied in many different forms and should not be construed as limited to the embodiments set forth herein. Omitted details and modifications or alternative embodiments are within the purview of persons of ordinary skill in the art. Furthermore, whereas particular embodiments of the invention have been described herein for the purpose of illustrating the invention and not for the purpose of limiting the same, it will be appreciated by those of ordinary skill in the art that numerous variations of the details, materials and arrangement of parts/elements/steps/functions may be made within the principle and scope of the invention without departing from the invention as described in the claims.

1. In a first entity, a method comprising:
obtaining a call option from a second entity, wherein the call option includes a first maturity date; and
issuing a forward contract to the second entity, wherein the forward contract includes a second maturity date.

2. The method of claim 1, wherein the first entity includes at least one of a financial entity and a business entity.

3. The method of claim 1, wherein the second entity includes at least one of a financial entity and a business entity.

4. The method of claim 1, wherein the second maturity date is after the first maturity date.

5. The method of claim 1, wherein the second maturity date is before the first maturity date.

6. The method of claim 1, wherein the second maturity date is the same as the first maturity date.

7. The method of claim 1, wherein the forward contract includes an obligation to transfer to the second entity at least one of dividends and distributions on a number of shares of stock of the second entity underlying the forward contract.

8. The method of claim 7, wherein the second entity pays a premium for the forward contract.

9. The method of claim 7, wherein transferring the at least one of dividends and distributions occurs at maturity of the forward contract.

10. The method of claim 7, wherein transferring the at least one of dividends and distributions occurs before maturity of the forward contract.

11. The method of claim 7, wherein transferring the at least one of dividends and distributions occurs after maturity of the forward contract.

12. The method of claim 7, wherein total shares outstanding of the second entity are reduced by the number of shares of stock of the second entity underlying the forward contract.

13. The method of claim 12, wherein transferring the at least one of dividends and distributions causes at least one of income of the second entity to remain substantially constant and earnings-per-share of the second entity to increase.

14. The method of claim 1, wherein the forward contract includes no obligation to transfer to the second entity at least one of dividends and distributions on a number of shares of stock of the second entity underlying the forward contract.

15. The method of claim 14, wherein total shares outstanding of the second entity are reduced by the number of shares of stock of the second entity underlying the forward contract.

16. The method of claim 15, wherein transferring the at least one of dividends and distributions causes at least one of income of the second entity to decrease and earnings-per-share of the second entity to remain substantially constant.

17. The method of claim 1, wherein total shares outstanding of the second entity are reduced by a number of shares of stock of the second entity underlying the forward contract.

18. The method of claim 1, wherein the call option includes a provision for assignment of the call option.

19. The method of claim 1, wherein the forward contract includes a provision for assignment of the forward contract.

20. The method of claim 1, wherein at least one of the call option and the forward contract provides a return to the second entity, wherein the return is substantially equivalent to tax-free interest.

21. The method of claim 1, wherein the first entity assumes the risk associated with at least one of the forward contract and the call option.

22. The method of claim 1, wherein the second entity assumes the risk associated with at least one of the forward contract and the call option.

23. The method of claim 1, wherein the first entity exercises the call option at maturity.

24. The method of claim 1, wherein the first entity does not exercise the call option.

25. The method of claim 1 further comprising pricing at least one of the forward contract and the call option.

26. The method of claim 1, wherein the first entity and the second entity enter into the forward contract and the call option simultaneously.

27. The method of claim 1, wherein the first entity and the second entity first enter into one of the forward contract and the call option.

28. A computer-readable medium including instructions for performing a method, said medium comprising:
instructions for obtaining a call option from a second entity, wherein the call option comprises a first maturity date; and
instructions for issuing a forward contract to the second entity, wherein the forward contract comprises a second maturity date.

29. A system comprising:
means for obtaining a call option from a second entity, wherein the call option comprises a first maturity date; and
means for issuing a forward contract to the second entity, wherein the forward contract comprises a second maturity date.

30. In a first financial entity, a method comprising:
structuring a transaction between a first entity and a second entity, wherein the transaction includes at least one of a forward contract and a call option.

31. The method of claim 30, wherein the first entity is at least one of a business entity and a second financial entity.

32. The method of claim 30, wherein the second entity is at least one of a business entity and a second financial entity.

33. The method of claim 30, wherein structuring includes pricing at least one of the forward contract and the call option.

34. The method of claim 30, wherein structuring includes marketing at least one of the forward contract and the call option.

35. The method of claim 30, wherein structuring includes underwriting at least one of the forward contract and the call option.

36. The method of claim 30, wherein structuring includes determining whether one of the first entity and the second entity will issue at least one of the forward contract and the call option.

37. The method of claim 30, wherein structuring includes determining at least one of terms and conditions on at least one of the forward contract and the call option.

38. A system comprising:
a computer associated with a business entity; and
a transaction computer associated with a financial entity, wherein the transaction computer is configured to obtain a call option from the business entity and issue a forward contract to the business entity.

39. The system of claim 38, wherein the computer associated with the business entity is configured to account for the call option and the forward contract.
